(19) United States
(12) Patent Application Publication
(10) Pub. No.: US 2002/0143794 A1
(43) Pub. Date: Oct. 3, 2002

(54) Method and system for converting data files from a first format to second format

(76) Inventor: David J. Helt, Forest, VA (US)

Correspondence Address: Jennifer A. Albert, Esq., Hunton & Williams, 1900 K Street, N.W., Washington, DC, 20006-1109, US

(21) Appl. No.: 09/821,041

(22) Filed: Mar. 30, 2001

(51) Int. Cl. G06F 12/00

(52) U.S. Cl. 707/200

(57) ABSTRACT

A method and system are provided for converting data files and associated information from a first file format to a second file format. Initially, at least one data file is extracted from a first format file server, with the at least one data file including a first format image portion and a first format work information portion. The first format image portion of the at least one data file is converted to a second format image portion. The first format work information portion is next converted to a second format work information image portion. A second format data file is created to include both the second format image portion and the second format work information image portion. This second format data file is then imported into a second format file server.

### BACKGROUND OF THE INVENTION

The present invention relates generally to a method and a system for converting computer-readable data from a first format to a second format and, more particularly, relates to a method and a system for converting data including image data from a first format to a second format.

Information management and information technology are two popular phrases related to how organizations control and disseminate information either internally or externally. Traditionally, businesses kept paper records or relied upon memory and word of mouth to maintain and share information. However, with the increasing size of business, came a need to manage the business' information in a much more secure and usable manner. With the advent of high powered computers and globally distributed networks, information including text, images and even audio data is often stored digitally and available to many remote users at the click of a button.

To facilitate this kind of data storage and management, businesses turned to software vendors to develop applications meeting the various needs of the businesses. In particular, businesses such as financial institutions, brokerage houses, and other customer service centered businesses needed tools for managing the information related to specific customers. This type of application became known as a customer relationship management solution or a CRM solution and provided businesses with an ability to share and manage customer information across multiple platforms and locations, thereby enabling the business to more effectively service the licensed customer. Examples of suitable CRM solutions include the Automated Work Distributor (AWD®) application licensed by DST Systems, Inc. and the FileNET® application licensed by FileNET, Inc.

Unfortunately, as businesses became ever more reliant upon the functions provided by a particular CRM solution, it became increasingly more difficult to transition the information from one CRM solution to another. Since different CRM solutions typically perform their functions in different ways, the manner of organizing data in one CRM solution is generally incompatible with that of a second CRM solution. One example of this incompatibility relates to a format of an image file used by the various CRIM solutions as well as a query format used to search and retrieve relevant information. Because of these incompatibilities, businesses are forced to factor in a cost of re-entering, re-keying or otherwise manually converting all of their information from one CRM solution in one legacy system to another CRM solution for a new system. Obviously, this creates a deterrent in transitioning between unrelated systems. Further, since information stored and used by a first system may not be used by a second system, simply transitioning between systems would result in a loss of the previously used information, a loss not necessarily in the best interest of the business.

Many methods and systems are known in the prior art for converting relatively simple data files from one format to another format. For example, most popular word processing applications include an ability to convert documents from or into numerous other formats. Similarly, several digital imaging applications enable users to easily convert images from a first image format to a second image format. However, none of the known methods for converting data files from a first format to a second format solve the problems associated with converting complex CRM or other information management-related information from one CRM application to another CRM application.

Therefore, there remains a need in the art of data conversion for an acceptable method of converting CRM related data having ancillary information included therewith into formats not supporting the inclusion of such ancillary information.

### BRIEF SUMMARY OF THE INVENTION

The present invention overcomes the problems noted above, and provides additional advantages, by providing for a method for converting data files and associated information from a first file format to a second file format. The method comprises the steps of extracting at least one data file from at least one first format file server, wherein the at least one data file includes a first format image portion and a first format work information portion. The first format image portion of the at least one data file is converted to a second format image portion. The first format work information portion of the at least one data file is next converted to a second format work information image portion. A second format data file is created to include both the second format image portion and the second format work information image portion. This second format data file is then imported into a second format file server. Methods, systems and programs in accordance with the present invention substantially increase the speed and efficiency with which businesses convert from legacy systems to new systems by providing for the conversion of data files from the legacy format to the new format. In particular, the present invention enables work product associated with the legacy data files which is not directly compatible with the new system to nonetheless be retained and subsequently retrievable by the new system.

### BRIEF DESCRIPTION OF THE DRAWINGS

The present invention can be understood more completely by reading the following Detailed Description of exemplary embodiments, in conjunction with the accompanying drawings, in which:

FIG. 1 is a block diagram of one embodiment of a computer system implementing the present invention;

FIG. 2 is a flow chart describing steps performed in a method for converting an image file using the system set forth in FIG. 1;

FIG. 3 is a flow chart showing one embodiment of steps 202-206 set forth briefly in FIG. 2 and relating to the retrieval and conversion of the legacy image files;

FIG. 4 is a mapping table for converting a business area index to a DocClass index in accordance with one embodiment of the present invention;

FIG. 5 is a mapping table for converting a Work Type index to a Doc Type index in accordance with one embodiment of the present invention;

FIG. 6 is a flow chart describing further processing which may be performed during the conversion steps briefly described in FIG. 2;

FIG. 7 is a flow chart describing steps performed in one embodiment of a method for verifying the integrity of converted image files and associated information.

### DETAILED DESCRIPTION OF THE INVENTION

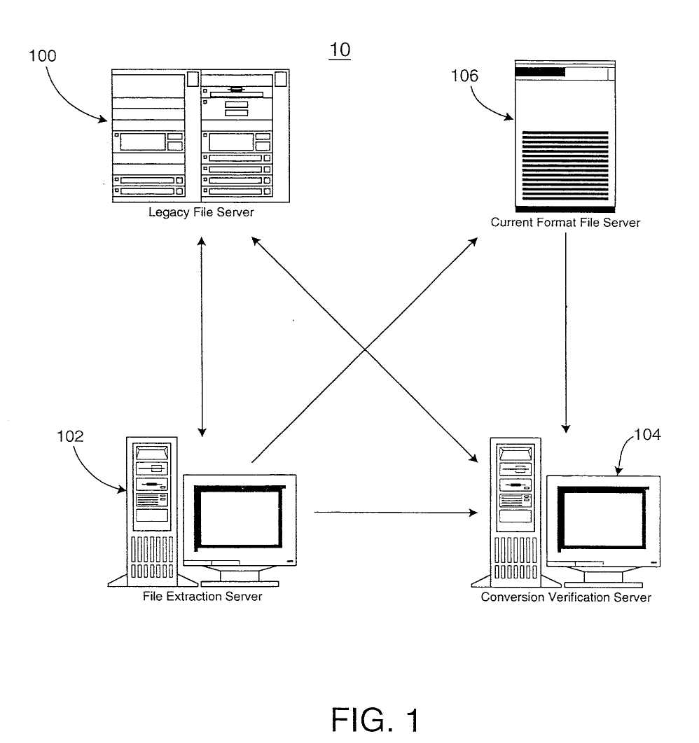

Referring to the Figures and specifically to FIG. 1, there is shown a block diagram illustrating one embodiment of a computer system 10 for implementing a method for converting data files in accordance with the present invention. In particular, a legacy file server 100 stores a plurality of legacy data files in a first file format. Preferably, each of the legacy data files are indexed in a plurality of manners so as to facilitate subsequent searching and retrieval. Further, the legacy file server 100 also includes a database for storing information relating to each particular legacy data file. This related information may be referred to as ‘work’ and specifically relates to historical usage or manipulation of the related legacy data file. The particularities of the file indexing and work history will be described in additional detail below.

A file extraction server 102 is electrically connected to the legacy file server 100. The electrical connection may be a direct local connection or a remote connection such as over a computer network or the like. As will be discussed in additional detail below, a file extraction program is resident on the file extraction server 102 and operates to retrieve and extract the legacy data files as well as their associated indexes and work history information. Further, the file extraction server 102 also operates to convert the legacy data files and related information into image files meeting a current selected format. The details of this conversion will be set forth in additional detail below.

A conversion verification server 104 is electrically connected to both the file extraction server 102 and the legacy file server 100. A conversion verification program resident on the conversion verification server 104 operates to ensure that the conversion made by the file extraction server 102 is completed without errors. As will be discussed in additional detail below, if errors are detected, the conversion verification server 104 acts to interrupt subsequent file importations and also electronically notifies suitable personnel of the problem.

A current format file server 106 is electrically connected to the file extraction server 102 and the conversion verification server 104. A file importation program resident on the current format file server 106 operates, upon legacy image file extraction and conversion by the file extraction server 102, to import the newly converted data files into the current format file server 106. As briefly mentioned above, importation of the data files may be aborted upon error determination by the conversion verification server 104. Further, it should be understood that, although the above operations have been described as being completed by separate and distinct server computers, more or fewer server computers may be implemented to perform these tasks.

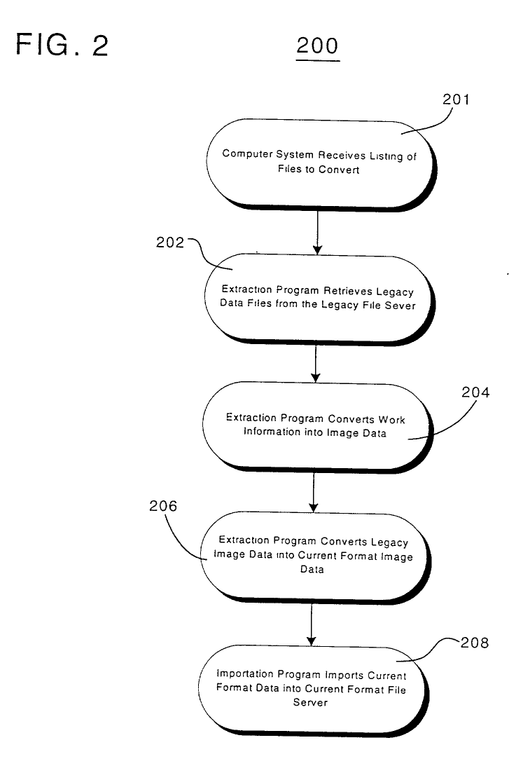

Referring now to FIG. 2, there is shown a flow chart describing a method 200 for converting an image file using the system 10 set forth in FIG. 1. For the purposes of simplicity, the method 200 described in FIG. 2 begins with a plurality of legacy data files being previously stored and indexed in accordance with a legacy file format. In step 201, a computer system receives, from a user, an identification of at least one file to be converted. In one embodiment, the legacy image files to be converted may be related to a plurality of insurance policies. In this example, the user may submit a listing of numbers for the insurance policies whose files are to be converted from the legacy file format to a current file format. In one embodiment, a report of files to be converted is generated in ASCII format. This report is then copied to an input directory of server 102 instructing the server to retrieve the files listed in the report.

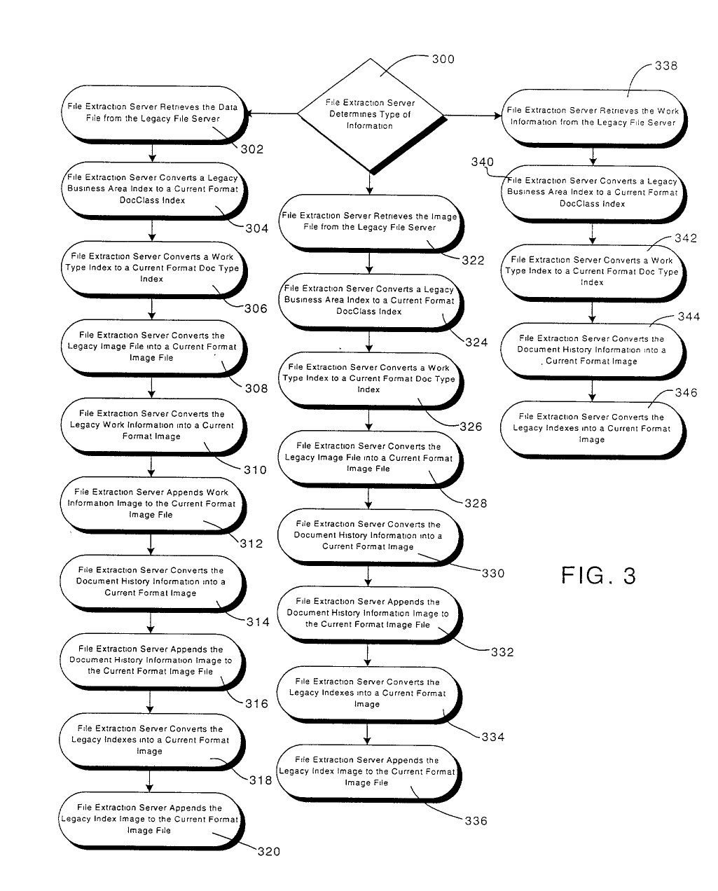

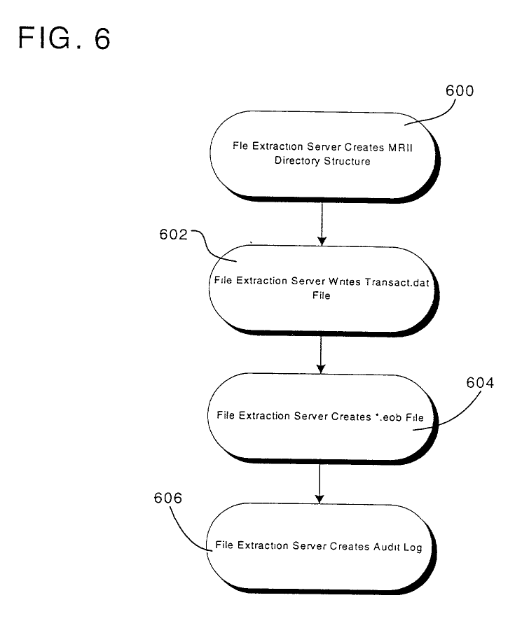

Once the computer system receives a listing of files to be converted, a file extraction program, in step 202, retrieves a plurality of legacy data files which include both an image portion as well as a plurality of portions related to any additional information associated with the image portion. As described above, a work information portion is preferably associated with each image portion of each legacy data file and includes information related to the historical usage and manipulation of the associated image portion of the legacy data file. In addition, an indexing information portion relating to the legacy data file is also stored on the legacy file server 100 so as to facilitate searching and retrieval of the legacy data file. In step 204, the file extraction program of the file extraction server 102 converts the work information portion associated with each legacy data file into image data. In step 206, the file extraction program converts each legacy image portion to a corresponding current format image file. In general terms, the conversion step 206 also includes a discrete step of appending the associated work information portion to the image portion as well as the step of converting the legacy indexing information portion associated with each legacy data file into current format indexing information and indexing image data associated with each new current format data file. Additional details and specificities relating to the conversion of legacy work and indexing information are set forth below in relation to FIGS. 3 and 6.

Once new current format data files and associated indexing information have been created by the file extraction program, the file importation program on the current format file server 106, in step 208, transfers the current format data files to the current format file server 106. Upon transfer of the current format data files to the current format file server 106, the current format data files are available for searching and retrieval by an application supporting the current format.

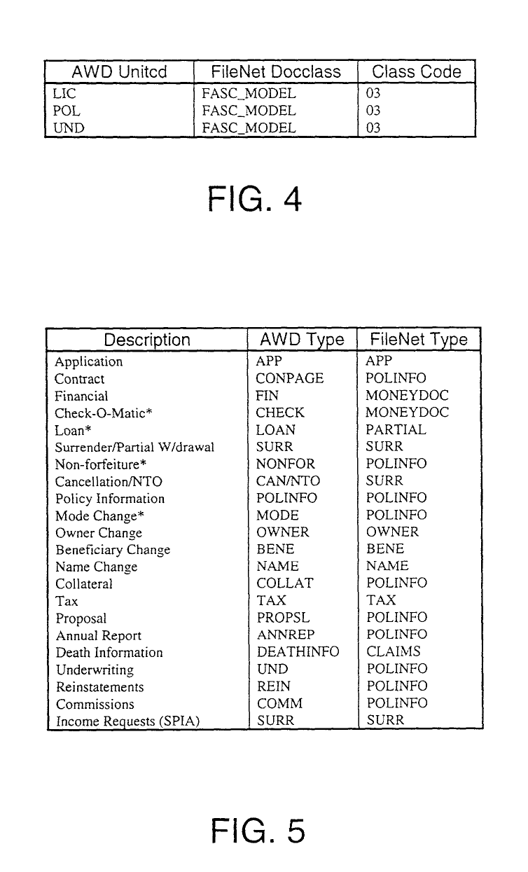

Referring now to FIG. 3, there is shown one embodiment of sub-steps executed in connection with the steps 202-206 set forth briefly above (shown in FIG. 2) relating to the retrieval and conversion of the legacy data files. In step 300, the file extraction server 102 first determines what kinds of information are associated with each submitted legacy data file. In particular, the file extraction server 102 determines whether the submitted legacy data file includes: 1) an image portion with an associated work information portion; 2) an image portion without an associated work information portion; or 3) a work information portion without an associated image portion. If it is determined in step 300 that the submitted legacy data file includes an image portion with an associated work information portion, the file extraction server 102, in step 302, retrieves the image portion and the associated work information portion for conversion. In step 304, the file extraction server 102 converts a legacy business area index associated with the legacy data file into an associated current format DocClass code utilizing a mapping table set forth in FIG. 4. Next, in step 306, the file extraction server 102 converts a legacy Work Type index associated with the legacy data file into an associated current format DocType index using a mapping table set forth in FIG. 5. In step 308, the file extraction server 102 converts the legacy image portion of the legacy data file into an associated current format image portion. In a preferred embodiment, the preferred current image format is the TIFF format.

In step 310, the file extraction server 102 converts the work information portion associated with the legacy data file into a current format work information image portion and, in step 312, appends the converted current format work information image portion to an end of the current format image portion created in step 308. In step 314, the file extraction server 102 converts the document history information portion associated with the legacy data file into a current format document history image portion and, in step 316, appends the converted current format document history image portion to the end of the current format image portion modified in step 312. In step 318, the file extraction server 102 converts any part of the legacy indexing information portion not associated with current format indexes into a current format indexing information image portion. In step 320, the file extraction server 102 appends the converted current format indexing information image portion to the current format image portion modified in step 316.

If it is determined in step 300 that the submitted legacy data file includes an image portion without an associated work information portion, the file extraction server 102, in step 322, retrieves the image portion and the indexing information portion for conversion. In step 324, the file extraction server 102 converts a legacy business area index associated with the legacy data file into an associated current format DocClass code utilizing the mapping table set forth in FIG. 4. Next, in step 326, the file extraction server 102 converts a legacy work type index associated with the legacy data file into an associated current format DocType index using the mapping table set forth in FIG. 5. In step 328, the file extraction server 102 converts the legacy image portion into an associated current format image portion. In a preferred embodiment, the preferred current image format is the TIFF format.

In step 330, the file extraction server 102 converts the document history information portion associated with the legacy data file into a current format history information image portion and, in step 332, appends the converted current format history information image portion to the end of the current format image portion converted in step 328. In step 334, the file extraction server 102 converts any legacy indexing information not associated with current format indexes into a current format indexing information image portion. In step 336, the file extraction server 102 appends the indexing image portion to the current format image file modified in step 332.

If it is determined in step 300 that the submitted legacy data file includes a work information portion without an associated image portion (e.g., the image portion has been previously converted or documentation has been generated without an associated image portion), the file extraction server 102, in step 338, retrieves the work information portion for conversion. In step 340, the file extraction server 102 converts a legacy business area index associated with the legacy data file into an associated current format DocClass code utilizing the mapping table set forth in FIG. 4. Next, in step 342, the file extraction server 102 converts a legacy work type index associated with the legacy data file into an associated current format DocType index using the mapping table set forth in FIG. 5. In step 344, the file extraction server 102 converts the document history information portion associated with the legacy data file into a current format history information image portion. In step 346, the file extraction server 102 converts any legacy indexing information not associated with current format indexes into a current format indexing information image portion.

As described generally above, in one exemplary embodiment of the present invention, the legacy data file format relates specifically to the AWD® family of customer relationship management software licensed by DST Systems, Inc. Further, the conversion method described above translates information formatted for AWD into information readable by a software application known as FileNET® licensed by FileNET Corporation.

Referring now to FIG. 6, there is shown a flow chart describing further processing steps which may be performed during the conversion steps briefly described in FIG. 2, above. In particular, in addition to converting the legacy data file image portion and any associated work information portion and indexing information portion as described in FIG. 3, the file extraction server 102 also prepares the newly created current format data files for importation into the current format file server 106. Preferably, this preparation includes formatting the information for importation using a data file importation application such as a Mid-Range Image Import (MRII) application licensed by FileNET, Inc.

In step 600, the file extraction server 102, for each converted legacy data file, creates a MRII directory structure associated with the new current format data file. This MRII directory structure includes a parent directory having therein a plurality of sub-directories for each converted legacy data file. Next, in step 602, the file extraction server 102 writes a MRII Transact.dat file relating to each converted legacy data file. Preferably the Transact.dat file includes the following information: a class code; a list of indexes associated with the class code; document data for the converted legacy data file including any unique file identifiers; and the image portion corresponding to the converted image portion, the associated work information portion, and the indexing information portion described briefly above. In step 604, the file extraction server 102 creates a MRII *.eob file associated with the converted image portion. The *.eob file is used by the MRII application to locate and transfer the converted legacy data files to the current format file server 106. In step 606, the file extraction server 102 creates an audit log file used by both the MRII application as well as the conversion verification program of the conversion verification server 104 to list the legacy data files converted by the file extraction server 102.

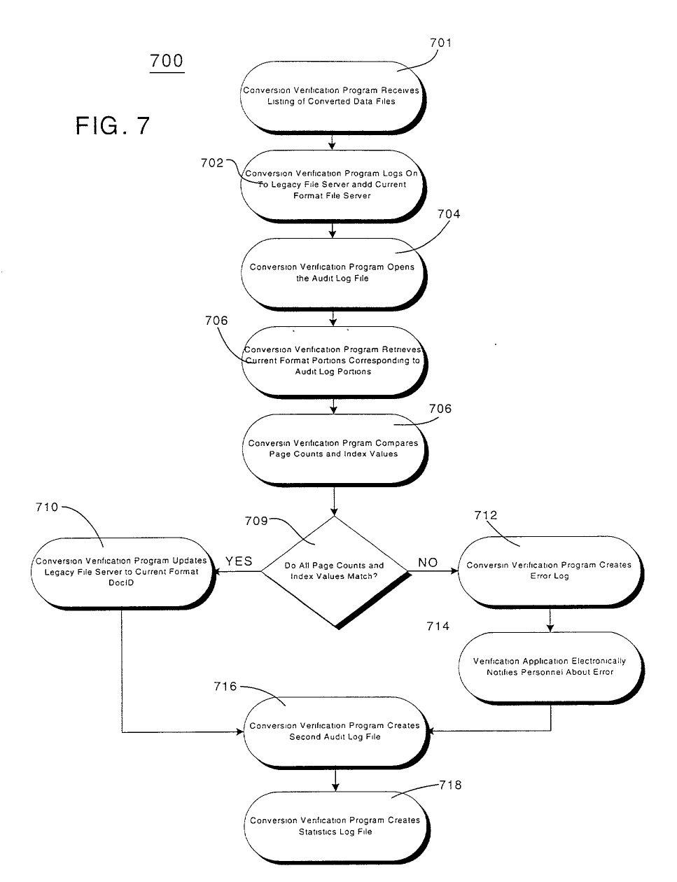

Referring now to FIG. 7, there is shown a flow chart describing the steps performed in one embodiment of a method 700 for verifying the integrity of converted legacy data files and associated information. As described above in connection with FIG. 1, the conversion verification server 104 is connected to the file extraction server 102 and includes a conversion verification program which operates to ensure that the converted legacy data files have been properly imported onto the current format file server 106. In step 701, the conversion verification program receives the listing of legacy data files to be converted. Next, in step 702, the conversion verification program logs on to both the legacy file server 100 and the current format file server 106.

For each legacy data file listed, the conversion verification program, in step 704, opens the associated audit log file created in step 606 above which contains a listing of all portions converted for the particular legacy data file. In step 706, for each portion listed in the audit log, the conversion verification program requests the corresponding portion from the current format file server 106. For each returned portion, the conversion verification program, in step 708, compares page counts and index values with the information contained in the audit log. If the page counts and index values match, the conversion verification program, in step 710, updates the legacy file server 100 with the current format docid. However, if the page counts and index values do not match, or if the listed portion was not found, the conversion verification program, in step 712, creates an error log identifying a location of an error. In a preferred embodiment, the conversion verification server 104, in step 714 also electronically notifies relevant personnel regarding a time, a nature and the location of the error.

In step 716, the conversion verification program generates a second audit log file for each corresponding input audit log file. This second audit log file contains one record for each converted portion and includes: a date and a time of the file extraction; a status of the conversion (identified as complete or error based upon the determination at step 708); the various indexes associated with the document and their values; the total page count for the portion; and the total number of history pages included with the portion. Next, in step 718, the conversion verification program generates a statistics log file for each audit log file processed. Each statistics log file includes: a date and a time stamp for the conversion verification processing, a name of the audit log file processed; a total number of portions associated with the particular audit log file; and a processing time in documents per minute.

By providing a single, comprehensive, easy to use system and method for converting legacy-compatible data files into current format data files, the present invention significantly reduces the time and effort required to covert from one software platform to another. Further, by restructuring non-compatible work product associated with the legacy files into image data, the work product of the prior system is not lost upon conversion. This feature significantly eases software system transition.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A method for converting a plurality of data files and associated information from a first file format to a second file format comprising the steps of:
extracting at least one data file from at least one first format file server, wherein the at least one data file includes a first format image portion and a first format work information portion;
converting the first format image portion of the at least one data file to a second format image portion;
converting the first format work information portion of the at least one data file to a second format work information image portion;
creating a second format data file including both the second format image portion and the second format work information image portion; and
importing the second format data file into a second format file server.

2. The method of claim 1, further comprising the step of receiving a listing of files to be converted from the first format to the second format, wherein the listing includes an identification of at least one file stored in a first file format;

3. The method of claim 1, further comprising the steps of:
determining an accuracy of the second format data file; and
generating an error message if it is determined that the second format data file is not accurate.

4. The method of claim 1, wherein said at least one first format data file further includes a first format indexing information portion.

5. The method of claim 4, further comprising the steps of:
converting at least a portion of said first format indexing information portion to second format indexing information portion;
converting a remaining portion of said first format indexing information portion to a second format indexing information image portion; and
appending said second format indexing information image portion to said second format data file.

6. A system for converting a plurality of data files and associated information from a first file format to a second file format comprising:
a legacy file server for storing a plurality of legacy data files in a first file format;
a file extraction program for retrieving and extracting the legacy data files as well as associated indexing and work history information from the legacy file server;
said file extraction program further operating to convert the legacy data files and related information into data files meeting a current selected format;
a conversion verification program for ensuring that the conversion made by the file extraction server is completed without errors; and
a file importation program for importing the newly converted data files into a current format file server.

7. The system of claim 6, wherein the file extraction program is resident on a file extraction server operatively connected to the legacy file server.

8. The system of claim 7, wherein the conversion verification program is resident on a conversion verification server operatively connected to the legacy file server and the file extraction server.

9. The system of claim 8, wherein the file importation program is resident on a current format file server operatively connected to the file extraction server and the conversion verification server.

10. The system of claim 9 wherein the legacy file server, the file extraction server, the conversion verification server, and the current format file server are operatively connected over a computer network.

11. The system of claim 6, wherein:
the plurality of legacy data files include a first format image portion and a first format work information portion;
the file importation program converts the first format image portion of the plurality of legacy data files to a second format image portion;
the file importation program converts the first format work information portion of the plurality of legacy data files to a second format work information image portion; and
the file importation program creates a second format data file including both the second format image portion and the second format work information image portion.

12. A computer readable storage medium including machine-readable language comprising one or more instructions for converting a plurality of data files and associated information from a first file format to a second file format, the instructions comprising:
one or more instructions for extracting at least one data file from at least one first format file server, wherein the at least one data file includes a first format image portion and a first format work information portion;
one or more instructions for converting the first format image portion of the at least one data file to a second format image portion;
one or more instructions for converting the first format work information portion of the at least one data file to a second format work information image portion;
one or more instructions for creating a second format data file including both the second format image portion and the second format work information image portion; and
one or more instructions for importing the second format data file into a second format file server.

13. The computer-readable storage medium of claim 12, further comprising one or more instructions for receiving a listing of files to be converted from the first format to the second format, wherein the listing includes an identification of at least one file stored in a first file format.

14. The computer-readable storage medium of claim 12, further comprising:
one or more instructions for determining an accuracy of the second format data file; and
one or more instructions for generating an error message if it is determined that the second format data file is not accurate.

15. The computer-readable storage medium of claim 12, wherein said at least one first format data file further includes a first format indexing information portion.

16. The computer-readable storage medium of claim 15, further comprising:
one or more instructions for converting at least a portion of said first format indexing information portion to second format indexing information portion;
one or more instructions for converting a remaining portion of said first format indexing information portion to a second format indexing information image portion; and
one or more instructions for appending said second format indexing information image portion to said second format data file.
